(19) United States
(12) Patent Application Publication
(10) Pub. No.: US 2016/0299574 A1
(43) Pub. Date: Oct. 13, 2016

(54) Method and System for Adjusting Viewing Angle of Display Automatically and a Display

(71) Applicant: BOE TECHNOLOGY GROUP CO., LTD., Beijing (CN)

(72) Inventor: Shuo Chen, Beijing (CN)

(21) Appl. No.: 14/409,463

(22) PCT Filed: Jun. 19, 2014
(86) PCT No.: PCT/CN2014/080277

§ 371 Date: Dec. 18, 2014

(30) Foreign Application Priority Data
Dec. 31, 2013 (CN) 201310753055.5

(51) Int. Cl. G06F 3/03; H04N 13/04; H04N 5/44

(52) U.S. Cl. CPC G06F 3/0325; H04N 5/4403; H04N 13/0429; H04N 13/0468; H04N 2005/4426

(57) ABSTRACT

The embodiment of the present disclosure relates to the technical field of display, in particular to a method and a system for adjusting the viewing angle of a display automatically and the display, which can solve problems in the prior art that the position of the viewer cannot be accurately determined and the viewing angle of the display cannot be adjusted automatically. The method for adjusting the viewing angle of a display automatically according to the embodiment of the present disclosure includes: calculating the included angles of a corresponding triangle taking the two signal receiving devices and the signal generating device as vertexes by two signal receiving devices based on received signals transmitted from the signal generating device; and determining a tilt angle between the signal generating device and the display panel plane based on the included angles; if the tilt angle is not within the predefined range of the tilt angle, rotating the display panel under control until the tilt angle is within the predefined range of the tilt angle. This method for adjusting the viewing angle of the display automatically can avoid the influence from non-viewers on adjusting of the viewing angle of the display and the adjusting accuracy of the viewing angle of the display can be improved.

### RELATED APPLICATIONS

The present application claims the benefit of Chinese Patent Application No. 201310753055.5, filed on Dec. 31, 2013, the entire disclosure of which is incorporated herein by reference.

### BACKGROUND OF THE DISCLOSURE

1. Field of the Disclosure

The present disclosure relates to the technical field of display, and in particular to a method and a system for adjusting the viewing angle of a display automatically and a display.

2. Description of the Prior Art

With the improvement of science and technology and the higher demanding of people's life quality, display has become a popular electronic product. Some of the current displays can adjust the viewing angle automatically so that the viewers can have more comfortable viewing results. The above noted viewing angle is the angle at which the display panel is directed towards the viewer.

In prior art, one of the methods for adjusting the angle of the display is to: adjust the display manually or control and adjust the display repeatedly by a remote control to obtain comfortable viewing angle. However, it needs the viewer to operate repeatedly to realize the comfortable viewing angle.

With the development of technology, another way to realize the adjusting of the viewing angle of the display is to: capture the image of the viewer by camera equipment mounted on the display; determine the position of the viewer by the display; and adjust the angle of the display. However, when a number of head portraits of viewers appear in the image captured by the camera equipment, it is hard to distinguish which is the viewer and which is interfering head portrait. Therefore, it is difficult to determine the position of the viewer accurately. It cannot be guaranteed that the real viewer can get better viewing angle.

### SUMMARY OF THE DISCLOSURE

The embodiment of the present disclosure is to provide a method and system for adjusting the viewing angle of a display automatically and the display, which can solve problems in the prior art that the position of the viewer cannot be accurately determined and the viewing angle of the display cannot be adjusted automatically.

An embodiment of the present disclosure provides a method for adjusting the viewing angle of a display automatically, including:

determining a first distance and a second distance between two signal receiving devices and a signal generating device respectively by the two signal receiving devices located on the same horizontal height of the display frame based on received signals transmitted from the signal generating device located outside the display;

calculating the included angle of a corresponding triangle taking the two signal receiving devices and the signal generating device as vertexes based on a third distance between the two signal receiving devices and the first distance and the second distance; and determining the tilt angle between the signal generating device and the display panel plane based on the included angle; if the tilt angle is not within the predefined range of the tilt angle, rotating the display panel under control until the tilt angle is within the predefined range of the tilt angle.

In the above embodiment, the position of the signal generating device, i.e. the position of the viewer is determined based on the signals transmitted by the signal generating device. After receiving signals, the signal receiving devices can determine a tilt angle between the signal generating device and the display panel plane, i.e. the tilt angle between the viewer and the display panel plane based on the received signal. If the tilt angle is not within the predefined range of the tilt angle, the display panel can be controlled to rotate. Because the position of the viewer is the same with the position of the signal generating device, the tilt angle between the viewer and the display panel plane can be determined based on the tilt angle between the signal generating device and the display panel plane, thereby to avoid the interference caused by non-viewers and accurately determine the best viewing angle between the viewer and the display panel plane.

In an embodiment of the present disclosure, the included angle between the first corresponding edge between one signal receiving device and the signal generating device and the second corresponding edge between the two signal receiving devices is taken as the relative tilt angle between the line connecting the signal generating device and the center point of the display panel and the plane in which the display panel is located; and the relative tilt angle is taken as the tilt angle between the signal generating device and the display panel plane. By using the tilt angle between the signal generating device and the display panel plane determined by the above method, the difference between the determined tilt angle and the actual tilt angle is less than 1 degree, but it is much more convenient to calculate.

Preferably, if the tilt angle is not within the predefined range of the tilt angle, rotating the display panel under control can specifically include: determining the angular difference between the tilt angle and the upper limit value or the lower limit value of the predefined range of the tilt angle; rotating the display panel, wherein the rotation angle value of the display panel is the determined angular difference. The embodiment of the present disclosure can rotate the display panel based on the resulting angular difference and the display panel can reach the proper viewing angle by only one rotation, which can increase the adjusting efficiency of the viewing angle significantly.

Preferably, if the tilt angle is not within the predefined range of the tilt angle, rotating the display panel under control can specifically include: rotating the display panel, wherein the rotation angle value of each rotation of the display panel is a fixed rotation angle value. The step of calculating the angular difference between (on one hand) the tilt angle between the signal generating device and the display panel plane and (on the other hand) the upper limit value or the lower limit value of the predefined angle range can be omitted, so that the complexity of the process can be reduced.

After rotating the display panel, determining whether the current tilt angle (i.e., add or subtract the fixed rotation angle to or from the original tilt angle) is within the predefined range of the tilt angle. If it is not within the predefined range of the tilt angle, the display panel is continued to be rotated until the tilt angle becomes within the predefined range of the tilt angle, so that the viewer can have better viewing angle.

An embodiment of the present disclosure also provides a display, including:

a display panel,

two signal receiving devices, which are configured to determine a first distance and a second distance between two signal receiving devices and a signal generating device respectively based on received signals transmitted from the signal generating device located outside the display, wherein the two signal receiving devices are disposed at the same horizontal height on the display frame;

a rotating mechanism, which is configured to rotate the display panel;

a control device, which is configured to calculate the included angle of a triangle taking the two signal receiving devices and the signal generating device as vertexes based on a third distance between the two signal receiving devices and the first distance and the second distance obtained from the two signal receiving devices respectively and determine the tilt angle between the signal generating device and the display panel plane based on the included angle; and if the tilt angle is not within the predefined range of the tilt angle, control the rotating mechanism to rotate the display panel until the tilt angle is within the predefined range of the tilt angle.

In the above embodiment, in determining the position of the signal generating device, i.e. the position of the viewer based on the signals transmitted by the signal generating device, after the signal receiving device receiving signals, the tilt angle between the signal generating device and the display panel plane, i.e. the tilt angle between the viewer and the display panel plane can be determined based on the received signal. If the tilt angle is not within the predefined range of the tilt angle, the display panel can be controlled to rotate. Because the position of the viewer is the same with the position of the signal generating device, the tilt angle between the viewer and the display panel plane can be determined based on the tilt angle between the signal generating device and the display panel plane, thereby to avoid the interference caused by non-viewers and accurately determine the best viewing angle between the viewer and the display panel plane.

Wherein the control device is specifically configured to:

take the included angle between the first corresponding edge between one signal receiving device and the signal generating device and the second corresponding edge between the two signal receiving devices as the relative tilt angle between the line connecting the signal generating device and the center point of the display panel and the plane in which the display panel is located; and take the relative tilt angle as the tilt angle between the signal generating device and the display panel plane. By using the tilt angle between the signal generating device and the display panel plane determined by the above method, the difference between the determined tilt angle and the actual tilt angle is less than 1 degree, but it is much more convenient to calculate.

The control device is specifically configured to:

determine the angular difference between the tilt angle and the upper limit value or the lower limit value of the predefined range of the tilt angle; control the rotating mechanism to rotate the display panel, wherein the rotation angle value of the display panel is the determined angular difference. The embodiment of the present disclosure can rotate the display panel based on the resulting angular difference and the display panel can reach the proper viewing angle by only one rotation.

The control device is specifically configured to:

control the rotating mechanism to rotate the display panel, wherein the angle value of each rotation of the display panel can be controlled to be a fixed rotation angle value. The step of calculating the angular difference between the tilt angle between the signal generating device and the display panel plane and the upper limit value or the lower limit value of the predefined angle range can be omitted, so that the complexity of the process can be reduced.

The control device is further configured to:

determine whether the current tilt angle is within the predefined range of the tilt angle after controlling the rotating mechanism to rotate the display panel; if not, continuing to control the rotating mechanism to rotate the display panel. By controlling the rotating mechanism to rotate the display panel several times, the tilt angle will become within the predefined range of the tilt angle so that the viewer can obtain better viewing angle.

Wherein, one of the two signal receiving devices is located at the center of the upper edge of the display frame and the other is located at an end of the upper edge of the display frame; or alternatively, one of the two signal receiving devices is located at the center of the lower edge of the display frame and the other is located at an end of the lower edge of the display frame; or alternatively, the two signal receiving devices are located at the centers of two side edges of the display frame. By locating one signal receiving device at the center of the upper edge or the lower edge of the display frame and locating the other signal receiving device at an end of the upper edge or the lower edge, the position of the signal generating device relative to the display panel plane can be easily determined, and the determined tilt angle is closer to the actual tilt angle.

An embodiment of the present disclosure provides a system for adjusting the viewing angle of a display automatically, comprising: a display as set forth above; and a signal generating device, which is configured to transmit signals that are used to determine the position of the signal generating device.

In the above embodiment, in determining the position of the signal generating device, i.e. the position of the viewer based on the signals transmitted by the signal generating device, after receiving signals, the signal receiving device can determine the tilt angle between the signal generating device and the display panel plane, i.e. the tilt angle between the viewer and the display panel plane based on the received signal. If the tilt angle is not within the predefined range of the tilt angle, the display panel can be controlled to rotate. Because the position of the viewer is the same with the position of the signal generating device, the tilt angle between the viewer and the display panel plane can be determined based on the tilt angle between the signal generating device and the display panel plane, thereby to avoid the interference caused by non-viewers and accurately determine the best viewing angle between the viewer and the display panel plane.

Preferably, the signal generating device is an infrared signal transmitter and the signal receiving devices are infrared sensors.

The embodiment of the present disclosure comprises: determining a first distance and a second distance between two signal receiving devices and a signal generating device respectively by the two signal receiving devices located on the same horizontal height of the display frame based on received signals transmitted from the signal generating device located outside the display; calculating the included angle of a triangle taking the two signal receiving devices and the signal generating device as vertexes based on a third distance between the two signal receiving devices and the first distance and the second distance; and determining the tilt angle between the signal generating device and the display panel plane based on the included angle; if the tilt angle is not within the predefined range of the tilt angle, rotating the display panel under control until the tilt angle is within the predefined range of the tilt angle. Because the position of the viewer can be accurately determined based on signals transmitted from the signal generating device and therefore the tilt angle between the signal generating device and the display panel plane can be determined, the display panel can be controlled to rotate to be within the predefined range of the tilt angle. The influence from non-viewer can be avoided on adjusting the angle of the display, so the adjusting accuracy of the viewing angle of the display can be improved.

### BRIEF DESCRIPTION OF DRAWINGS

FIG. 1 is a schematic flow chart of a method for adjusting a display automatically according to an embodiment of the present disclosure;

FIG. 2 is a schematic view showing a tilt angle between the signal generating device and the display panel plane according to an embodiment of the present disclosure;

FIG. 3 is a schematic flow chart showing the method for adjusting the angle of the display based on angular difference between (on one hand) the tilt angle between the signal generating device and the display panel and (on the other hand) the predefined range of the tilt angle according to an embodiment of the present disclosure;

FIG. 4 is a schematic flow chart of a method for angle adjusting by controlling the display panel to be rotated by a fixed rotation angle;

FIG. 5 is a schematic view of a display according to an embodiment of the present disclosure;

FIG. 6 is a schematic view of two signal receiving devices according to an embodiment of the present disclosure, wherein, one signal receiving device is located at the center of the bottom edge of the display screen, and the other is located at an end of the bottom edge of the display screen;

FIG. 7 is a schematic view of a display comprising a control device according to an embodiment of the present disclosure;

FIG. 8 is a schematic view of a system for adjusting a display automatically according to an embodiment of the present disclosure;

FIG. 9 is a schematic view of the signal generating device embedded in a remote control and a 3 D glasses.

### DETAILED DESCRIPTION OF THE PRESENT DISCLOSURE

The embodiment of the present disclosure is to provide a method and system for adjusting the viewing angle of a display automatically and the display, which can solve problem in the prior art display that when the position of the viewer is determined by capturing human head information by means of camera equipment, it is prone to be interfered by the presence of the head of non-viewer, so that the position of the real viewer cannot be accurately determined. Besides, installing the camera equipment on the display can increase the cost of the display device. By means of the present disclosure, the accuracy of the angle adjusting of the display can be improved.

The present disclosure will be described in more detail in conjunction with the drawings.

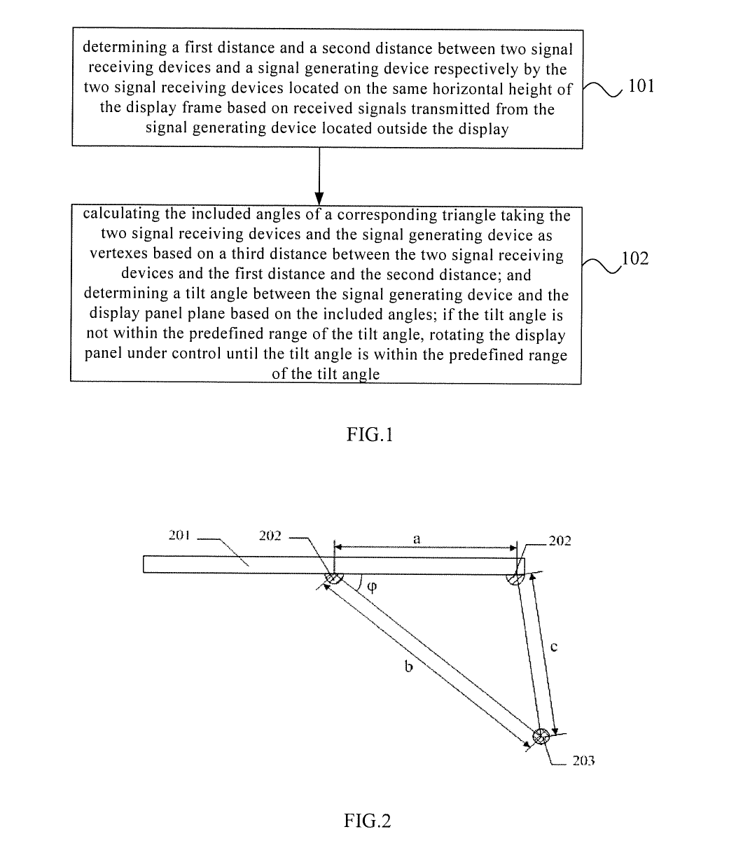

FIG. 1 is a schematic flow chart of a method for adjusting a display automatically according to an embodiment of the present disclosure. The method comprises:

step 101: determining a first distance and a second distance between two signal receiving devices and a signal generating device respectively by the two signal receiving devices located on the same horizontal height of the display frame based on received signals transmitted from the signal generating device located outside the display;

step 102: calculating the included angle of a corresponding triangle taking the two signal receiving devices and the signal generating device as vertexes based on a third distance between the signal receiving devices and the first distance and the second distance; and, determining the tilt angle between the signal generating device and the display panel plane based on the included angle; if the tilt angle is not within the predefined range of the tilt angle, rotating the display panel under control until the tilt angle is within the predefined range of the tilt angle.

In the above embodiment, in determining the position of the signal generating device, i.e. the position of the viewer based on the signals transmitted by the signal generating device, after receiving signals, the signal receiving device can determine the tilt angle between the signal generating device and the display panel plane, i.e. the tilt angle between the viewer and the display panel plane based on the received signal. If the tilt angle is not within the predefined range of the tilt angle, the display panel can be controlled to rotate. Because the position of the viewer is the same with the position of the signal generating device, the tilt angle between the viewer and the display panel plane can be determined based on the tilt angle between the signal generating device and the display panel plane, thereby to avoid the interference caused by non-viewers and accurately determine the best viewing angle between the viewer and the display panel plane.

In step 101, the display includes at least two signal receiving devices, wherein the two signal receiving devices used to receive the signals transmitted by the signal generating device must be located at the same horizontal height. For example, the two signal receiving devices can be located at the lower edge or the upper edge of the display frame, and the distance between the two signal receiving devices is a predefined distance; or alternatively, the two signal receiving devices can be located at the same horizontal height at the side edge of the display frame. Preferably, one of the two signal receiving devices can be located at the center of the lower edge of the display frame, and the other can be located at an end of the lower edge; or alternatively, one of the two signal receiving devices can be located at the center of the upper edge of the display frame and the other can be located at an end of the upper edge; or alternatively, the two signal receiving devices can be located at the centers of the two side edges of the display frame.

The signal generating device can be embedded in the following devices: the remote control, or 3D glasses. The signal generating device can be an infrared transmitter and the like.

In step 102, the tilt angle between the signal generating device and the display panel plane can be determined based on the included angles, which includes the following steps in detail: taking the included angle between the first corresponding edge between one signal receiving device and the signal generating device and the second corresponding edge between the two signal receiving devices as the relative tilt angle between the line connecting the signal generating device and the center point of the display panel and the plane in which the display panel is located; taking the relative tilt angle as the tilt angle between the signal generating device and the display panel plane.

As shown in FIG. 2, taking one of the two signal receiving devices located at the center of the lower edge of the display frame and the other located at an end of the lower edge of the display frame as an example, wherein 201 is the display, 202 is the signal receiving device, the determined distance between the two signal receiving devices is a third distance a; the distance between the center of the lower edge of the display frame and the signal generating device 203 is a first distance b; the distance between the signal receiving device located at an end of the lower edge of the display frame and the signal generating device 203 is a second distance c. The included angles of the corresponding triangle taking the two signal receiving devices and the signal generating device as vertexes can be calculated based on the third distance a between the two signal receiving devices and the first distance b and the second distance c. The tilt angle between the signal generating device and the display panel plane can be determined based on the included angles. In FIG. 2, the included angle φ between the first corresponding edge between the signal receiving device at the center of the lower edge of the display frame and the signal generating device and the second corresponding edge between the two signal receiving device can be viewed as the tilt angle between the line connecting the signal generating device and the center point of the display panel and the plane where the display panel is located, the formula is as follows:

cos ∠φ=(a²+b²−c²)/2ab;

Wherein, φ is the tilt angle between the line connecting the signal generating device and the center point of the display panel and the plane where the display panel is located; a is the length of the corresponding edge between the two signal receiving devices; b is the length of the corresponding edge between the signal receiving device located at the center of the lower edge of the display frame and the signal generating device; and c is the length of the corresponding edge between the signal receiving device at an end of the lower edge of the display frame and the signal generating device.

There is some difference between (on one hand) the included angle between the first corresponding edge (which is between one signal receiving device and the signal generating device) and the second corresponding edge (which is between the two signal receiving devices) and (on the other hand) the actual tilt angle between the line connecting the signal generating device and the center point of the display panel and the plane where the display panel is located, but the difference is very slight. Taking a 55 inch TV and the viewer being at a distance of 300 cm from the TV as an example, within the height range of the TV frame, the difference between the included angle and the tilt angle is about 0.3 degree.

As to the above determined tilt angle between the signal generating device and the display panel plane, the difference between the tilt angle and the actual tilt angle is less than 1 degree, but it is much more convenient to calculate.

The predefined range of the tilt angle can vary based on the position of the signal receiving devices. Taking one of the two signal receiving devices located at the center of the lower edge of the display frame and the other located at an end of the lower edge of the display frame as an example, preferably the predefined range of the tilt angle is 45°˜135°. If the signal receiving devices are located at any other positions, the tilt angle can be calculated according to the positions, which will not be described in more detail herein.

In step 102, when the tilt angle between the signal generating device and the display panel plane is not in the predefined range, rotating the display panel under control specifically includes the following two situations which will be described in more detail respectively.

1. Determining the angular difference between (on one hand) the tilt angle between the signal generating device and the display panel plane and (on the other hand) the predefined range of the tilt angle.

The tilt angle between the signal generating device and the display panel plane can be determined. Whether the tilt angle is within the predefined range of the tilt angle can be determined. If the tilt angle is not within the predefined range of the tilt angle, the angular difference between (on one hand) the tilt angle between the signal generating device and the display panel plane and (on the other hand) the upper limit value or the lower limit value of the predefined range of the tilt angle can be determined and the determined angular difference can be taken as the rotation angle of the display panel. The rotating mechanism can be controlled to rotate the display panel so that the tilt angle between the signal generating device and the display panel plane can become within the predefined range of the tilt angle by only rotating once. The current tilt angle between the signal generating device and the display panel plane after rotating can remain unchanged.

Taking the two signal receiving devices shown in FIG. 2 as an example, if the tilt angle between the signal generating device and the display panel plane is 15° and therefore the tilt angle between the current signal generating device and the display panel plane is not within 45°-135°, the angular difference between the current tilt angle and the lower limit value of the predefined range of the tilt angle is 30°. Then the display panel can be rotated 30° to the left under control. If the tilt angle between the signal generating device and the display panel plane is 150° and therefore the tilt angle between the current signal generating device and the display panel plane is not within 45°-135°, the angular difference between the current tilt angle and the upper limit value of the predefined range of the tilt angle is 15°. Then the display panel can be rotated 10° to the right under control.

The method can rotate the display panel based on the resulting angular difference and the display panel can reach proper viewing angle by only one rotation.

2. Determining a fixed rotation angle of the display panel

The tilt angle between the signal generating device and the display panel plane can be determined. Whether the tilt angle is within the predefined range of the tilt angle can be determined. If the tilt is not within the predefined range of angle, the display panel will be rotated under control and the angular value of each rotation of the display panel can be controlled to be a fixed rotation angle value.

Because the angular value of each rotation of the display panel can be controlled to be a fixed rotation angle value, the step of calculating the angular difference between the tilt angle between the signal generating device and the display panel plane and the upper limit value or the lower limit value of the predefined angle range can be omitted, so that the complexity of the process can be reduced.

Furthermore, after rotating the display panel under control, whether the current tilt angle is within the predefined range of the tilt angle will be determined. If the current tilt angle is not within the predefined range of the tilt angle, the process will return to control the rotating mechanism to rotate the display panel and the process will go on to the next step. If the tilt angle between the signal generating device and the display panel plane is within the predefined range of the tilt angle, the tilt angle will remain unchanged. The fixed rotation angle of the display panel can be set as needed, such as 2°, 5°, 8°, 10°, 15°, 20°, 25°, 30°, 35°, 40°, 45° or 50° and the like, and the set rotation angle is no more than 90° at the maximum.

Taking the positions of the two signal receiving devices shown in FIG. 2 as an example, the predefined fixed rotation angle of the display panel can be 20°. If the tilt angle between the signal generating device and the display panel plane is determined to be 15° and therefore the tilt angle between the current signal generating device and the display panel plane is not within the predefined range of the tilt angle 45°-135°, the display panel will be rotated 20° to the left under control. After rotating the display panel, the tilt angle between the current signal generating device and the display panel plane is determined to be 35° and therefore the tilt angle between the current signal generating device and the display panel plane is not within the predefined rang of tilt angle 45°-135°, the display panel is continued to be rotated 20° to the left. After rotating the display panel, the tilt angle between the current signal generating device and the display panel plane is within 45°-135° and the current angle remains unchanged. If the tilt angle between the signal generating device and the display panel plane is determined to be 150° and therefore the current tilt angle is not within the predefined range of the tilt angle 45°-135°, the display panel can be controlled to rotate 20° to the right. After rotating the display panel, the tilt angle between the signal generating device and the display panel plane is determined to be 130° and therefore the tilt angle between the current signal generating device and the display panel plane is within the predefined range of the tilt angle, the current tilt angle can remain unchanged.

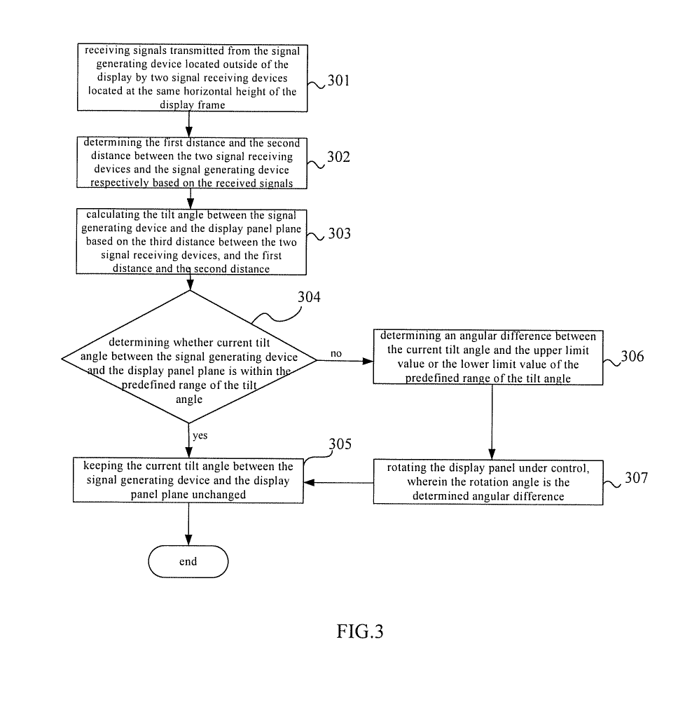

FIG. 3 shows a method for adjusting the viewing angle of a display based on the angular difference between (on one hand) the tilt angle between the signal generating device and the display panel plane and (on the other hand) the predefined range of the tilt angle, wherein one of the two signal receiving devices is located at the center of the lower edge of the display frame, and the other of the two signal receiving devices is located at an end of the lower edge of the display frame. The method includes:

in step 301: receiving signals transmitted from a signal generating device located outside of the display by two signal receiving devices located at the same horizontal height of display frame;

in step 302: determining a first distance and a second distance between the two signal receiving devices and the signal generating device respectively;

in step 303: determining the tilt angle between the signal generating device and the display panel plane based on the third distance between the two signal receiving devices, and the first distance and the second distance;

in step 304: determining whether the tilt angle is within the predefined range of the tilt angle, if it is within the predefined angle range, going to step 305; otherwise going to step 306;

in step 305: keeping the tilt angle between the current signal generating device and the display panel plane unchanged and ending the process;

in step 306: determining the angular difference between the current tilt angle and the upper limit value or the lower limit value of the predefined range of the tilt angle;

in step 307: rotating the display panel under control, wherein the rotation angle is the determined angular difference. Because this method can rotate the display panel to proper viewing angle by only one rotation, after the rotating, the tilt angle between the current signal generating device and the display panel plane can remain unchanged (that is, performing step 305).

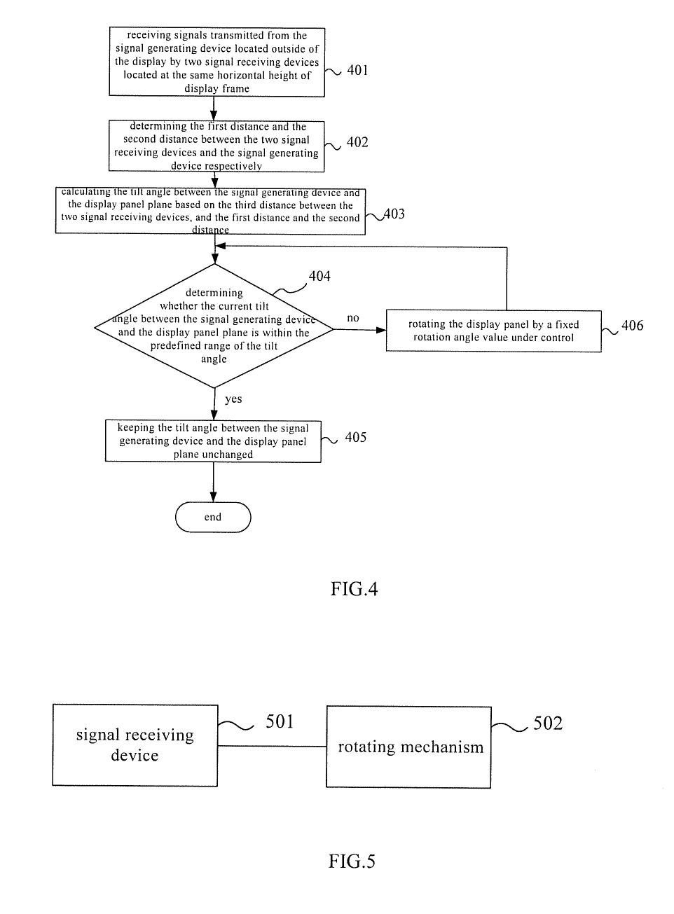

FIG. 4 shows a method for controlling the fixed rotation angle of the display panel according to an embodiment of the present disclosure, wherein one of the two signal receiving devices is located at the center of the lower edge of the display frame, and the other of the two signal receiving devices is located at an end of the lower edge of the display frame. The method includes:

in step 401: receiving signals transmitted from a signal generating device located outside of the display by two signal receiving devices located at the same horizontal height of display frame;

in step 402: determining a first distance and a second distance between the two signal receiving devices and the signal generating device respectively;

in step 403: calculating the tilt angle between the signal generating device and the display panel plane based on the third distance between the two signal receiving devices, and the first distance and the second distance;

in step 404: determining whether the tilt angle is within the predefined range of the tilt angle, if it is within the predefined angle range, going to step 405; otherwise going to step 406;

in step 405: keeping the tilt angle between the current signal generating device and the display panel plane unchanged and ending the process.

in step 406: rotating the display panel by fixed rotation angle value under control and then returning to step 404.

Based on the same inventive concept, an embodiment of the present disclosure also provides a display. Because the principle of the solution of the display is the same with the method for adjusting the viewing angle of the display, the descriptions of the method embodiment can be applied to the embodiment of the display, and the repeated portion of the description of the display embodiment will not be described in more detail.

FIG. 5 shows a display according to an embodiment of the present disclosure, including a display panel and signal receiving devices 501 and a rotating mechanism 502.

The two signal receiving devices 501 are configured to determine a first distance and a second distance between two signal receiving devices and a signal generating device respectively based on received signals transmitted from the signal generating device located outside the display, wherein the two signal receiving devices are located on the same horizontal height on the display frame.

The rotating mechanism 502 is configured to rotate the display panel.

It should be noted that the number two of the signal receiving devices 501 is only illustrative. In an embodiment of the present disclosure, the display includes at least two signal receiving devices 501, wherein two signal receiving devices 501 used to receive the signals transmitted by the signal generating device must be located at the same horizontal height. For example, the two signal receiving devices 501 can be located at the lower edge or the upper edge of the display frame, and the distance between the two signal receiving devices 501 is a predefined distance; or alternatively, the two signal receiving devices 501 can be located at the same horizontal height at the side edge of the display frame. Preferably, one of the two signal receiving devices 501 can be located at the center of the lower edge of the display frame, and the other can be located at an end of the lower edge; or alternatively, one of the two signal receiving devices 501 can be located at the center of the upper edge of the display frame and the other can be located at an end of the upper edge; or alternatively, the two signal receiving devices 501 can be located at the centers of the two side edges of the display frame.

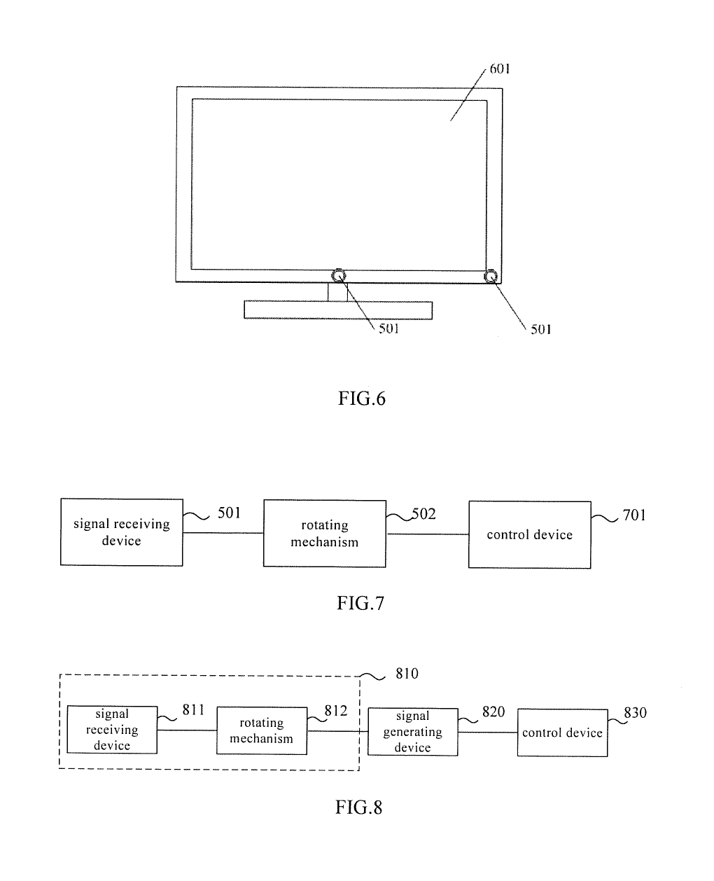

FIG. 6 shows an embodiment of the present disclosure, wherein one of the two signal receiving device 501 is located at the center of the lower edge of the display 601′ frame, and the other is located at an end of the lower edge of the display 601′ frame, and wherein the two signal receiving devices are located at the same height at the lower edge of the display frame.

Preferably, as shown in FIG. 7, the embodiment of the present disclosure also includes a control device 701, which is configured to calculate the included angle of a triangle taking the two signal receiving devices and the signal generating device as vertexes based on a third distance between the two signal receiving devices and the first distance and the second distance obtained from the two signal receiving devices respectively; and determine the tilt angle between the signal generating device and the display panel plane based on the included angle; and if the tilt angle is not within the predefined range of the tilt angle, control the rotating mechanism to rotate the display panel until the tilt angle is within the predefined range of the tilt angle.

The control device 701 is configured to determine the tilt angle between the signal generating device and the display panel plane based on the included angle, specifically by the following steps:

taking the included angle between the first corresponding edge between one signal receiving device 501 and the signal generating device and the second corresponding edge between the two signal receiving devices 501 as the relative tilt angle between the line connecting the signal generating device and the center point of the display panel and the plane in which the display panel is located; taking the relative tilt angle as the tilt angle between the signal generating device and the display panel plane. As shown in FIG. 2, taking one of the two signal receiving devices 501 located at the center of the lower edge of the display frame and the other located at an end of the lower edge of the display frame as an example, the determined distance between the two signal receiving devices 501 is a third distance a; the distance between the center of the lower edge of the display frame and the signal generating device 501 is a first distance b; the distance between the signal receiving device 501 located at an end of the lower edge of the display frame and the signal generating device is a second distance c. The included angle φ between the first corresponding edge between the signal receiving device at the center of the lower edge of the display frame and the signal generating device and the second corresponding edge between the two signal receiving device can be viewed as the tilt angle between the line connecting the signal generating device and the center point of the display panel and the plane where the display panel is located, the formula is as follows:

cos ∠φ=(a²+b²−c²)/2ab;

Wherein, φ is the tilt angle between the line connecting the signal generating device and the center point of the display panel and the plane where the display panel is located; a is the length of the corresponding edge between the two signal receiving devices; b is the length of the corresponding edge between the signal receiving device at the center of the lower edge of the display frame and the signal generating device; and c is the length of the corresponding edge between the signal receiving device at an end of the lower edge of the display frame and the signal generating device.

The control device 701 determines whether the tilt angle between the signal generating device 501 and the display panel plane is within the predefined range of the tilt angle and rotates the display panel under control, which includes the following two situations which will be described in more detail respectively.

1. The control device 701 is configured to determine the angular difference between (on one hand) the tilt angle between the signal generating device and the display panel plane and (on the other hand) the predefined range of the tilt angle.

The control device 701 is configured to determine the tilt angle between the signal generating device and the display panel plane; determine whether the tilt angle is within the predefined range of the tilt angle; if not, determine the angular difference between (on one hand) the tilt angle between the signal generating device and the display panel plane and (on the other hand) the upper limit value or the lower limit value of the predefined range of the tilt angle and take the determined angular difference as the rotation angle of the display panel and control the rotating mechanism 502 to rotate the display panel so that the tilt angle between the signal generating device and the display panel plane can become within the predefined range of the tilt angle by only rotating once. The tilt angle between the signal generating device and the display panel plane after rotating can be dictated by the control device 701 and the current tilt range can remain unchanged.

2. The control device 701 is configured to determine a fixed rotation angle of the display panel.

The control device 701 is configured to determine the tilt angle between the signal generating device and the display panel plane; determine whether the tilt angle is within the predefined range of the tilt angle; if not, control the rotating mechanism to rotate the display panel and control the angular value of each rotation of the display panel performed by the rotating mechanism 502 to be a fixed rotation angle value.

Furthermore, after rotating the display panel by controlling the rotating mechanism 502, the control device 701 is configured to determine whether the current tilt angle is within the predefined range of the tilt angle; if not, continue to control the rotating mechanism 502 to rotate the display panel; if the tilt angle between the signal generating device and the display panel plane is within the predefined range of the tilt angle, keep the tilt angle unchanged. The fixed rotation angle of the display panel can be set as needed, and the set rotation angle is no more than 90° at the maximum.

FIG. 8 shows a system for adjusting the viewing angle of the display automatically according to an embodiment of the present disclosure. The system includes: a display 810; a signal generating device 820 and a control device 830.

The display 810 includes a display panel (which is not shown in FIG. 8), two signal receiving devices 811 and a rotating mechanism 812. Wherein two signal receiving devices 501 are configured to determine a first distance and a second distance between two signal receiving devices and a signal generating device respectively based on received signals transmitted from the signal generating device located outside the display, wherein the two signal receiving devices are located on the same horizontal height of the display frame. The rotating mechanism 812 is configured to rotate the display panel.

The signal generating device 820 is configured to transmit signals used to determine the positions of the signal generating devices.

The control device 830 is configured to calculate the included angle of a triangle taking the two signal receiving devices and the signal generating device viewed as vertexes based on a third distance between the two signal receiving devices and the first distance and the second distance obtained from the two signal receiving devices respectively; and determine the tilt angle between the signal generating device and the display panel plane based on the included angle; and if the tilt angle is not within the predefined range of the tilt angle, control the rotating mechanism to rotate the display panel until the tilt angle is within the predefined range of the tilt angle.

It should be noted that the number two of the signal receiving devices 811 is only illustrative. In an embodiment of the present disclosure, the display includes at least two signal receiving devices 811, wherein the two signal receiving devices 811 used to receive the signals transmitted by the signal generating device 820 are located at the same horizontal height. For example, the two signal receiving devices 811 can be located at the lower edge or the upper edge of the display 810's frame, and the distance between the two signal receiving devices 811 is a predefined distance; or alternatively, the two signal receiving devices 811 can be located at the same horizontal height at the side edge of the display 810 frame. Preferably, one of the two signal receiving devices 811 can be located at the center of the lower edge of the display 810's frame, and the other can be located at an end of the lower edge; or alternatively, one of the two signal receiving devices 811 can be located at the center of the upper edge of the display 810's frame and the other can be located at an end of the upper edge; or alternatively, the two signal receiving devices 811 can be located at centers of two side edges of the display 810's frame.

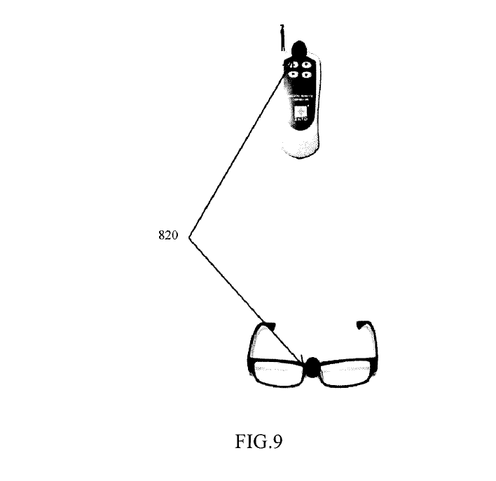

As shown in FIG. 9, the signal generating device 820 according to an embodiment of the present disclosure can be embedded in the following devices: remote control, or 3D glasses. When the signal generating device 820 is embedded in the 3D glasses, it is preferably embedded in a position between the two eyeglasses, or can be embedded in any position at the border of the frame of the glasses. The signal generating device 820 according to an embodiment of the present disclosure can be an infrared signal transmitter and the like. The signal receiving devices 811 can be infrared sensors. The distance between the signal generating device 820 and the signal receiving devices 811 can be determined by receiving the infrared signals transmitted by the signal generating device 820.

The control device 830 is configured to calculate the included angle of a triangle taking the two signal receiving devices 811 and the signal generating device 820 as vertexes based on a third distance between the two signal receiving devices 811 and the first distance and the second distance obtained from the two signal receiving devices 811 respectively; and determine the tilt angle between the signal generating device 820 and the panel plane of the display 810 based on the included angle; and if the tilt angle is not within the predefined range of the tilt angle, control the rotating mechanism 812 to rotate the display panel until the tilt angle is within the predefined range of the tilt angle.

The control device 830 is configured to determine the tilt angle between the signal generating device 820 and the display panel plane based on the included angle, specifically by the following steps:

taking the included angle between the first corresponding edge between one signal receiving device 811 and the signal generating device 820 and the second corresponding edge between the two signal receiving devices 811 as the relative tilt angle between the line connecting the signal generating device 820 and the center point of the display panel and the plane in which the display panel is located; taking this relative tilt angle as the tilt angle between the signal generating device and the display panel plane. Taking one of the two signal receiving devices 811 located at the center of the lower edge of the display frame and the other located at an end of the lower edge of the display 810's frame as an example, the determined distance between the two signal receiving devices 811 is a third distance a; the distance between the center of the lower edge of the display 810's frame and the signal generating device 820 is a first distance b; the distance between the signal receiving device 811 located at an end of the lower edge of the display frame and the signal generating device 820 is a second distance c. The included angle φ between the first corresponding edge between the signal receiving device 811 at the center of the lower edge of the display 810's frame and the signal generating device 820 and the second corresponding edge between the two signal receiving device 811 can be regarded as the tilt angle between the line connecting the signal generating device 820 and the center point of the display panel and the plane where the display panel is located, the formula is as follows:

cos ∠φ=(a²+b²−c²)/2ab;

Wherein, φ is the tilt angle between line connecting the signal generating device and the center point of the display panel and the plane where the display panel is located; a is the length of the corresponding edge between the two signal receiving devices; b is the length of the corresponding edge between the signal receiving device located at the center of the lower edge of the display frame and the signal generating device; and c is the length of the corresponding edge between the signal receiving device at an end of the lower edge of the display frame and the signal generating device.

The control device 830 determines whether the tilt angle between the signal generating device 820 and if the tilt angle is not within the predefined range of the tilt angle, rotates the display panel under control, which includes the following two situations which will be described in more detail respectively.

1. The control device 830 is configured to determine the angular difference between (on one hand) the tilt angle between the signal generating device and the display panel plane and (on the other hand) the predefined range of the tilt angle.

The control device 830 is configured to determine the tilt angle between the signal generating device 820 and the display panel plane; determine whether the tilt angle between the signal generating device 820 and the display panel plane is within the predefined range of the tilt angle. If it is not within the predefined range of the tilt angle, the control device 830 is configured to determine the angular difference between (on one hand) the tilt angle between the signal generating device 820 and the display panel plane and (on the other hand) the upper limit value or the lower limit value of the predefined range of the tilt angle and take the determined angular difference as the rotation angle of the display 810's panel and control the rotating mechanism 812 to rotate the display panel so that the tilt angle between the signal generating device 820 and the display panel plane can become within the predefined range of the tilt angle by only rotating once. The tilt angle between the signal generating device 820 and the display panel plane after rotating can be dictated by the control device 830 and the current tilt range can remain unchanged.

2. The control device 830 is configured to determine a fixed rotation angle of the display panel.

The control device 830 is configured to determine the tilt angle between the signal generating device 820 and the display panel plane; determine whether the tilt angle is within the predefined range of the tilt angle; if not, control the rotating mechanism 812 to rotate the display panel and control the angular value of each rotation of the display panel performed by the rotating mechanism 502 to be a fixed angular number. After rotating the display panel by controlling the rotating mechanism 812, the control device 830 is configured to determine whether the current tilt angle is within the predefined range of the tilt angle. If the current tilt angle is not within the predefined range of the tilt angle, it will continue to control the rotating mechanism 812 to rotate the display panel; if the tilt angle between the signal generating device and the display panel plane is within the predefined range of the tilt angle, it will keep the tilt angle unchanged. The fixed rotation angle of the display panel can be set as needed, and the set rotation angle is no more than 90°.

Obviously, those skilled in the art can make various medications and variations to the present disclosure without departing from the spirit and scope of the present disclosure. In this connection, all these modifications and variations are within the scope of the claims and the equivalent of the present disclosure and are construed as embraced by the present disclosure.

In this present disclosure, words such as “a” or “an” do not precludes plurality and phrases such as “first ” or “second ” do not mean order in time or position between those elements. These words or phrases are only used for convenience but not limiting the scope of the present disclosure.

1. A method for adjusting the viewing angle of a display automatically, comprising:
determining a first distance and a second distance between two signal receiving devices and a signal generating device respectively by the two signal receiving devices located on the same horizontal height of the display frame based on received signals transmitted from the signal generating device located outside the display;
calculating the included angles of a corresponding triangle taking the two signal receiving devices and the signal generating device as vertexes based on a third distance between the two signal receiving devices and the first distance and the second distance; and
determining a tilt angle between the signal generating device and the display panel plane based on the included angles; if the tilt angle is not within a predefined range of the tilt angle, rotating the display panel under control until the tilt angle is within the predefined range of the tilt angle.

2. The method according to claim 1, wherein determining the tilt angle between the signal generating device and the display panel plane based on the included angles specifically comprises:
taking an included angle between a first corresponding edge between one signal receiving device and the signal generating device and a second corresponding edge between the two signal receiving devices as a relative tilt angle between a line connecting the signal generating device and a center point of the display panel and a plane in which the display panel is located; taking the relative tilt angle as the tilt angle between the signal generating device and the display panel plane.

3. The method according to claim 1, wherein if the tilt angle is not within the predefined range of the tilt angle, rotating the display panel under control specifically comprises:
determining an angular difference between the tilt angle and an upper limit value or a lower limit value of the predefined range of the tilt angle; rotating the display panel, wherein the rotation angle value of the display panel is the determined angular difference.

4. The method according to claim 1, wherein if the tilt angle is not within the predefined range of the tilt angle, rotating the display panel under control specifically comprising:
rotating the display panel, wherein the angle value of each rotation of the display panel is a fixed rotation angle value.

5. The method according to claim 4, wherein the method further comprises:
determining whether current tilt angle is within the predefined range of the tilt angle after rotating the display panel, and if not, continuing to rotate the display panel.

6. A display comprising a display panel, wherein the display further comprises:
two signal receiving devices, which are configured to determine a first distance and a second distance between two signal receiving devices and a signal generating device respectively based on received signals transmitted from the signal generating device located outside the display, wherein the two signal receiving devices are located on the same horizontal height of the display frame;
a rotating mechanism, which is configured to rotate the display panel;
a control device, which is configured to calculate included angles of a triangle taking the two signal receiving devices and the signal generating device as vertexes based on a third distance between the two signal receiving devices and the first distance and the second distance obtained from the two signal receiving devices respectively and determine a tilt angle between the signal generating device and the display panel plane based on the included angles; and if the tilt angle is not within a predefined range of the tilt angle, control the rotating mechanism to rotate the display panel until the tilt angle is within the predefined range of the tilt angle.

7. The display according to claim 6, wherein the control device is specifically configured to:
take an included angle between a first corresponding edge between one signal receiving device and the signal generating device and a second corresponding edge between the two signal receiving devices as a relative tilt angle between a line connecting the signal generating device and a center point of the display panel and a plane in which the display panel is located; take the relative tilt angle as the tilt angle between the signal generating device and the display panel plane.

8. The display according to claim 6, wherein the control device is specifically configured to:
determine an angular difference between the tilt angle and an upper limit value or a lower limit value of the predefined range of the tilt angle; control the rotating mechanism to rotate the display panel and the rotation angle value of the display panel is the determined angular difference.

9. The display according to claim 6, wherein the control device is specifically configured to:
control the rotating mechanism to rotate the display panel, wherein the angle value of each rotation of the display panel is a fixed rotation angle value.

10. The display according to claim 9, wherein the control device is specifically configured to:
after controlling the rotating mechanism to rotate the display panel, determine whether current tilt angle is within the predefined range of the tilt angle, if not, control the rotating mechanism to continue to rotate the display panel.

11. The display according to claim 6, wherein one of the two signal receiving devices is located at the center of the upper edge of the display frame and the other is located at an end of the upper edge of the display frame; or alternatively
one of the two signal receiving devices is located at the center of the lower edge of the display frame and the other of the two signal receiving devices is located at an end of the lower edge of the display frame; or
the two signal receiving devices are located at the centers of two side edges of the display frame.

12. A system for adjusting the viewing angle of a display automatically, wherein the system comprises:
a display and a signal generating device which is configured to transmit signals that are used to determine the position of the signal generating device, the display comprising:
a display panel;
two signal receiving devices, which are configured to determine a first distance and a second distance between two signal receiving devices and a signal generating device respectively based on received signals transmitted from the signal generating device located outside the display, wherein the two signal receiving devices are located on the same horizontal height of the display frame:
a rotating mechanism, which is configured to rotate the display panel;
a control device, which is configured to calculate included angles of a triangle taking the two signal receiving devices and the signal generating device as vertexes based on a third distance between the two signal receiving devices and the first distance and the second distance obtained from the two signal receiving devices respectively and determine a tilt angle between the signal generating device and the display panel plane based on the included angles; and if the tilt angle is not within a predefined range of the tilt angle, control the rotating mechanism to rotate the display panel until the tilt angle is within the predefined range of the tilt angle.

13. The system according to claim 12, wherein the signal generating device is an infrared signal transmitter and the signal receiving devices are infrared sensors.

14. The display according to claim 7, wherein one of the two signal receiving devices is located at the center of the upper edge of the display frame and the other is located at an end of the upper edge of the display frame; or alternatively
one of the two signal receiving devices is located at the center of the lower edge of the display frame and the other of the two signal receiving devices is located at an end of the lower edge of the display frame; or
the two signal receiving devices are located at the centers of two side edges of the display frame.

15. The display according to claim 8, wherein one of the two signal receiving devices is located at the center of the upper edge of the display frame and the other is located at an end of the upper edge of the display frame; or alternatively
one of the two signal receiving devices is located at the center of the lower edge of the display frame and the other of the two signal receiving devices is located at an end of the lower edge of the display frame; or
the two signal receiving devices are located at the centers of two side edges of the display frame.

16. The display according to claim 9, wherein one of the two signal receiving devices is located at the center of the upper edge of the display frame and the other is located at an end of the upper edge of the display frame; or alternatively
one of the two signal receiving devices is located at the center of the lower edge of the display frame and the other of the two signal receiving devices is located at an end of the lower edge of the display frame; or
the two signal receiving devices are located at the centers of two side edges of the display frame.

17. The display according to claim 10, wherein one of the two signal receiving devices is located at the center of the upper edge of the display frame and the other is located at an end of the upper edge of the display frame; or alternatively
one of the two signal receiving devices is located at the center of the lower edge of the display frame and the other of the two signal receiving devices is located at an end of the lower edge of the display frame; or
the two signal receiving devices are located at the centers of two side edges of the display frame.

18. The system according to claim 12, wherein the control device is specifically configured to:
take an included angle between a first corresponding edge between one signal receiving device and the signal generating device and a second corresponding edge between the two signal receiving devices as a relative tilt angle between a line connecting the signal generating device and a center point of the display panel and a plane in which the display panel is located; take the relative tilt angle as the tilt angle between the signal generating device and the display panel plane.

19. The system according to claim 18, wherein the signal generating device is an infrared signal transmitter and the signal receiving devices are infrared sensors.

20. The system according to claim 12, wherein the control device is specifically configured to:
determine an angular difference between the tilt angle and an upper limit value or a lower limit value of the predefined range of the tilt angle; control the rotating mechanism to rotate the display panel and the rotation angle value of the display panel is the determined angular difference.
